(19) United States
(12) Patent Application Publication
(10) Pub. No.: US 2008/0104503 A1
(43) Pub. Date: May 1, 2008

(54) System and Method for Creating and Transmitting Multimedia Compilation Data

(75) Inventors: Chris Beall, San Jose, CA (US); Hitesh Shah, Mumbai (IN); Narayanaswamy Viswanathan, Palo Alto, CA (US)

Correspondence Address: SNELL & WILMER L.L.P. (Main), 400 EAST VAN BUREN, ONE ARIZONA CENTER, PHOENIX, AZ, 85004-2202, US

(73) Assignee: QLIKKIT, INC., Mountain View, CA (US)

(21) Appl. No.: 11/553,832

(22) Filed: Oct. 27, 2006

(51) Int. Cl. G06F 17/00; G06F 7/00

(52) U.S. Cl. 715/233; 715/201; 715/203; 715/230; 707/100

(57) ABSTRACT

This disclosure generally may disclose an efficient and easy to use system and method for sending combined captured data, and synchronized audio/visual annotation data.

### FIELD

This disclosure generally may describe a system and method for creating and sending multimedia data. More specifically, this disclosure may provide for an efficient and easy to use system and method for creating and sending combined captured data, and synchronized audio/visual annotation data.

### BACKGROUND

An estimated more than 30 billion non-spam emails may be sent each day. One of the largest drawbacks of utilizing email or text-type communications is the possibility and the likelihood that the message will be misinterpreted, in that the recipient may read unintended tone and feeling into the text message. This may cause unintended reactions, and may create interpersonal problems, among other drawbacks. Furthermore, text-type communications may not allow a user to easily refer to objects or regions of interest within communicated data.

### SUMMARY

The present disclosure may provide for a system and method for enhancing the information included in a communication. The present disclosure may allow a user to capture their digital experience by combining captured data with synchronized annotation data, thus creating a “digital show and tell.” Visual annotation data such as but not limited to, highlighting, circling, pointing, etc. may be overlaid onto captured data to indicate a portion of the captured data of interest. While the visual annotation data is being created, audio annotation data may also be created. The visual and audio annotation data may then be synchronized such that, when the combined captured data and annotation data are combined, a multimedia compilation is created. The audio data, in one embodiment voice data, may be replayed to recreate the experience the user had when creating the combined data.

Furthermore, the system may be capable of being easily used, and the created multimedia compilations may be stored, indexed, searched, and reutilized. This may be very advantageous to create, maintain, and search “how to” libraries, and/or corporate knowledge, among many other applications.

This system and method may be a powerful software debugging tool as a beta tester may capture the error that occurred, and may add annotation data explaining what action was taken to cause the error with the software. This system may also be utilized for obtaining feedback from users on the likes and dislikes of software and user interfaces. Another utilization of the system of this disclosure may be for creating sequenced audio data, along with digital photographs to better explain occurrences and/or to send digital talking picture albums.

The saving of the multimedia compilations may also create a reliable cache as the captured data may not be changed and may be an excellent record of how the information, such as a website, appeared at the time the multimedia compilation was produced. The system also allows for recipients to add additional overlays, such that many users may add annotation data to allow for remote users to more effectively communicate and collaborate on a project.

For most users, speaking may be many times faster than using a keyboard. In an embodiment, the subject of the present disclosure may allow a user to add a layer of information to one or more captured frames by simply talking while at the same time using the computer mouse or other pointer to select and highlight areas of interest of the captured data. By using voice as a primary annotation technique, this may free the user's hands to add additional valuable information by pointing and selecting areas. As a result, the user may use pointing and selection as a shorthand method to eliminate the need to describe points and areas of interest on the screen. The user may say, for example, “This button would look better if it were the same size and color as these menu choices,” while pointing at the button during the first part of the sentence, and the menu choices in the second part. It may not be necessary for the user to describe or otherwise verbally guide the reader to the objects and points of interest. This may reduce the number of words required to get the idea across, while simultaneously improving the accuracy of the communication by reliably conveying information about which points or areas of interest are important.

In an embodiment, the subject of the present disclosure may allow a user to more accurately describe their experience in using the computer as it is occurring. By allowing the user to generate immediate commentary on any collection of captured frames, the disclosed system and method may reduce errors caused by forgetting or incompletely recalling significant details.

In an embodiment, the subject of the present disclosure may allow a user to comment using voice, which carries additional valuable information concerning the user's mental and emotional states through tone, loudness, cadence, and pauses.

In an embodiment, the subject of the present disclosure may combine the user's voice along with any pointing or highlighting into a package that may include the software required to replay the user's synchronized commentary. In an embodiment, the self-executing packaging of the user's commentary may increase the reliability of communication by avoiding reliance on existing software on the receiving user's computer.

In an embodiment, the subject of the present disclosure may utilize existing email infrastructure, including email servers and associated network bandwidth that may be generally purchased at a fixed price per month, or included for free as part of an advertising scheme, such as Google's gmail.

### BRIEF DESCRIPTION OF THE DRAWINGS

The figures in this document illustrate various embodiments, which may include part or all of the features shown in one of these figures, or may include features from two or more figures. Embodiments may also include features described in the specification, or limitations to features described in the specification. Furthermore, embodiments may include features that would be familiar to a person of ordinary skill in the art, having studied this document.

FIG. 1 is a block diagram illustrating various components of an embodiment of a data creating and transmitting system;

FIG. 2 is a flow chart illustrating an embodiment of a method of creating and transmitting multimedia data;

FIG. 3 illustrates captured data and a user interface according to an embodiment;

FIG. 4 illustrates captured data and annotation data according to an embodiment;

FIG. 5 illustrates captured data and annotation data according to an embodiment; and

FIG. 6 is a block diagram of a computing platform capable of executing data manipulation in accordance with one or more embodiments.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

Some portions of the detailed description that follows are presented in terms of processes, programs and/or symbolic representations of operations on data bits and/or binary digital signals within a computer memory, for example. These process descriptions and/or representations may include techniques used in the data processing arts to convey the arrangement of a computer system and/or other information handling system to operate according to such programs, processes, and/or symbolic representations of operations.

A process may be generally considered to be a self-consistent sequence of acts and/or operations leading to a desired result. These include physical manipulations of physical quantities. Usually, though not necessarily, these quantities take the form of electrical and/or magnetic signals capable of being stored, transferred, combined, compared, and/or otherwise manipulated. It may be convenient at times, principally for reasons of common usage, to refer to these signals as bits, values, elements, symbols, characters, terms, numbers and/or the like. However, these and/or similar terms may be associated with the appropriate physical quantities, and are merely convenient labels applied to these quantities.

Unless specifically stated otherwise, as apparent from the following discussions, throughout the specification, discussion utilizing terms such as processing, computing, calculating, determining, and/or the like, refer to the action and/or processes of a computing platform such as computer and/or computing system, and/or similar electronic computing device, that manipulate and/or transform data represented as physical, such as electronic, quantities within the registers and/or memories of the computer and/or computing system and/or similar electronic and/or computing device into other data similarly represented as physical quantities within the memories, registers and/or other such information storage, transmission and/or display devices of the computing system and/or other information handling system.

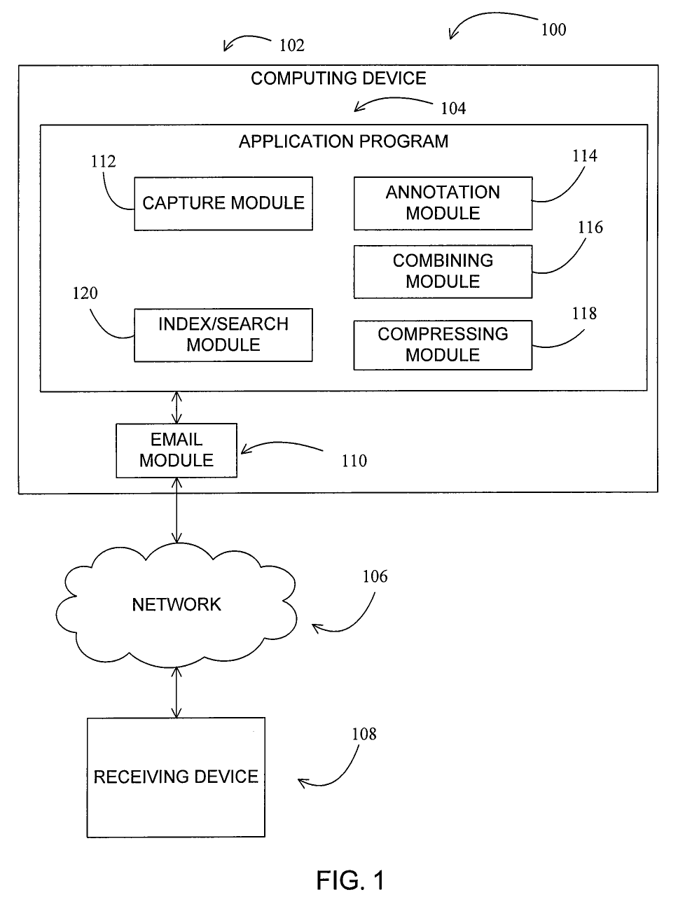

The present disclosure may include systems and methods of creating and sending media compilation data. FIG. 1 is a block diagram illustrating various components of an embodiment of a data storing and accessing system 100. System 100 may include a computing device 102. Computing device 102 may include an application program 104, as well as a communication module 110. Computing device 102 may be capable of communicating via communication module 110 via network 106 to receiving device 108.

In this embodiment, application program 104 may include a capture module 112. Capture module 112 may be capable of capturing data, such as image data, among other types of data. In an embodiment, capture module 112 may be capable of capturing a screen shot or portion thereof for use by the application program 104. The capture module 112 may also be capable of capturing meta data, and/or data such as location, geometry and value of web links, locations of buttons and other controls, date/time of capture, and identity of the instance of the application program that executed the capture, among other data.

Application program 104 may also include an annotation module 114, capable of receiving user inputs, and creating annotation data which may be associated with the captured data from capture module 112. The annotation information may include audio, visual, text, and/or other data, and/or combinations thereof. The annotation data may be associated with the captured data. In an embodiment, the captured data may include text, such as capturing the body of a text email for the purpose of replying to it by adding annotation data. Furthermore, the application program 104 may provide an ability for the user to enter text, such as a new email body, and then annotate it with voice, visual data, text comments, and/or other annotation data, and/or combinations thereof.

In an embodiment, annotation data may include visual data, such as user initiated annotations, such as circles, squares, arrows, or other indicators of portions of interest of captured data. Annotation data may also include audio data which may describe the captured data and other annotated data such that the captured data and annotated data may better explain edits and/or changes the user may indicate as data of interest from within the captured data. The annotation data may also include text data that a user may enter at various portions of captured data to further explain impressions, changes, or any other information the user may want to communicate. In this manner, inflections, as well as actual voice information data may be included to better explain impressions and/or changes, or other information the user may want to convey.

Furthermore, the annotation data may be synchronized such that the visual markings made by a user may be synchronized with the audio data inputted by a user, such that the user may indicate a particular portion of the captured data that attracted their attention and the audio data may speak about the indicated captured data that the visual indicator may point towards. The user may enter visual data and audio data somewhat at the same time. This may save time and allow a user to enter more information in a shorter amount of time. Furthermore, this may allow a user to better communicate because both audio and visual information is included, and the user may not have to only verbally or textually indicate impressions and/or describe data of interest.

Application program 104 in this embodiment may also include a combining module 116. Combining module 116 may be capable of combining the captured data from capture module 112 and the annotation data from annotation module 114, such that they may be associated and utilized by other modules and/or devices.

Furthermore, combining module 116 may be capable of synchronizing the annotation data such that the various types of annotation data will appear with nearly the same timing as when the user created them. Alternatively, another module, either shown or not shown in this disclosure, may be capable of accomplishing the synchronization. In one embodiment, this synchronization may be accomplished with the use of time stamping. However, many other synchronization techniques may be utilized without straying from the concepts disclosed here.

Application program 104 may include a compressing module 118, which may be capable of compressing the combined data to save as a smaller file and/or to transmit to another device to save space and/or bandwidth. The captured data and the annotation data may be compressed individually or together as a compilation, and/or combinations thereof. Furthermore, an executable player application program may also be compressed and sent with the compressed or uncompressed combined data. This may allow a relatively smaller file, in an embodiment from 1 k-999 k, to be sent to a recipient. The recipient may then utilize the player application program to view the combined data.

Combining module 116 may also be capable of providing the multimedia compilation, such as a movie in a standard format such as .avi or .mpeg for use by a recipient who has not installed the player application. Combining module may also generate an overview of the contents of the multimedia compilation that may include a compressed animation, such as animated .gif, along with other information such as text annotations, which may be presented as an email body to which the multimedia compilation is attached.

Application program 104 in this embodiment may also include a voice to text module 120 which may be capable of receiving the audio annotation data and converting it to a searchable text. Furthermore, a voice to text module may also be capable of performing an optical character recognition (OCR) on the captured data to create text that may be searchable. Alternatively, another module, either shown or not shown in this disclosure, may be capable of accomplishing the OCR function.

This may allow index/search module 122 to create a searchable collection of combined data such that combined data instances and/or topics may be reviewed and reutilized as needed. This may allow a company or person to keep a “how-to” collection of multimedia compilations. Furthermore, this may also allow a company to capture corporate knowledge and library or archive it for later use. In one embodiment, the combined data may be a file and may be referred to as a media compilation file. These media compilation files may then be indexed and stored such that they may be searchable and reusable.

Once the data is combined, it may be communicated through communication module 110 via a network 106 to a receiving device 108. In one embodiment, the combined data may be compressed before communicating. Furthermore, in one embodiment the network may be the Internet or other system capable of transmitting data.

In one embodiment, communication module 110 may be an e-mail program, however the scope of this disclosure is not limited to e-mail applications only. Furthermore, receiving device 108 may be another computing device and/or any other device capable of receiving information. Receiving device 108 may also include a mobile phone, PDA, and/or a media player, such as an iPod®-type device, and/or combinations thereof. In an embodiment, either the computing device 102 and/or the receiving device 108 may be a digital camera. The captured data may be a digital image, and the annotation data may be any data capable of being added by the device and/or software. The receiving device may also be capable of performing similar applications to those described above, and may be capable of assigning more annotation information in a similar manner.

This system and method may be capable of communicating more information than just a normal e-mail or text type communication, in that the actual user voice, such that inflection, etc. may be received by an end user such, that more information may be capable of being conveyed. Furthermore, the end user may remember or recall more information about a previous discussion of the subject matter of the data once the voice and words are heard again. This may allow advantages over text type only communications.

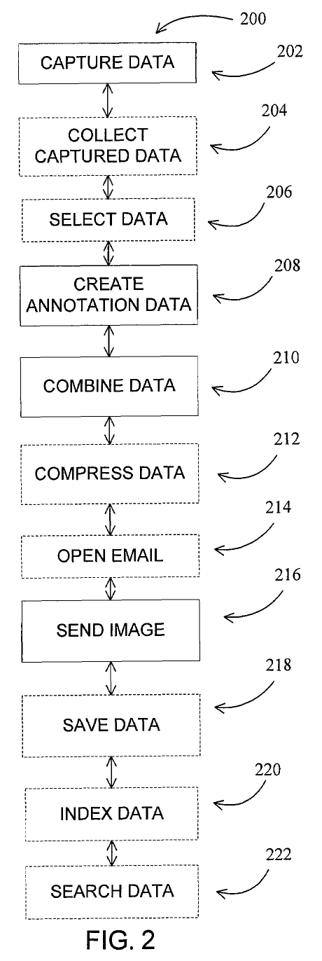

FIG. 2 is a flowchart illustrating the embodiment of a method 200 of creating and transmitting multimedia data. Method 200 may include capturing data at 202. Capturing data may be accomplished, at least in part, via a screen capture, portion of a screen capture, or another method for capturing data. In an embodiment, this may be a screen capture and the data may be saved as a .jpg and/or other picture-type information, additional data such as text, web links, and/or other data, and/or combinations thereof.

In an embodiment, a user may use the application program to create an email from scratch, composing text, which may be considered the “captured data”, then overlaying annotation data, such as voice and drawing annotation on it. Similarly, the user may “capture” the body of an email for the purpose of replying to the email with a combination of annotation data, such as optional text typed in the “body” of the email, as with a standard email replay, enhanced with voice, drawing and text annotations.

Method 200 may also include collecting the captured data at 204. More than one instance of a data capture may occur, and the respective data captures may be collected and displayed such that the captured data at 204 may optionally be selected at 206. In one embodiment, the instances may be displayed as thumbnails of the captured data. A user may select and annotate one or more instances of captured data.

Annotation data may then be created at 208. Annotation data may include audio, visual and/or text, data, and/or combinations thereof. The user may indicate portions of the captured data to create visual annotation data and may also create audio annotation data via a microphone, or other type device, such that when re-played, the visual annotation data and audio annotation data will be synchronized. This may somewhat recreate the experience similar to the sequence that the user created it. This may enhance the information included in the communication. Furthermore, this may be similar to the user and the receiver being in the same room and the user indicating a visual annotation data while speaking about the visual annotation data and the captured data it indicates.

Visual annotation data may be replayed in the order it was created to appear similar to animation. The visual annotation data along with synchronized audio annotation data may be played, and appear similar to narrated animation, and/or audio visual information, such as but not limited to a movie.

The annotation data and captured data may then be combined and/or associated at 210 to form a multimedia compilation. The annotation data may be synchronized such that the visual and audio may be synchronized to re-create a similar experience to when the annotation data was created. In one embodiment, the captured data may be image data, and the visual annotation data may be a separate file. The information of the visual annotation data may be overlaid over the captured data, such that the captured data is not edited and/or affected.

The combined data may optionally be compressed at 212. The annotation data may explain, highlight, or indicate portions of the captured data to enhance communication. The annotation and/or captured data may be compressed separately or combined and compressed. Similarly, a single application program capable of playing back the combined data may also be combined and/or associated with the combined data. Similarly, the application program may be compressed separately, or together with the other data.

In one embodiment, a collection of files (.xml files, captured data, visual data files, and associated audio narrations in .wav files) may be compressed into a zip archive. This archive may be appended to a viewer executable application program. This executable application program may be zipped and mailed to various recipients. Upon receipt of this .zip file in e-mail and/or other communication method, the end user may extract the contents and play the executable file, which may start the viewer. Upon starting, the viewer executable application program (having available its own file size) may read the archive contents out, and may extract them to a temporary folder so that these can be read and played.

A transmitting module may be opened at 214. In an embodiment, this may allow the multi-media compilation to be sent to a receiving device at 216. The transmitting module, in an embodiment, may include an e-mail-type program, however the data may be sent and/or transmitted in any manner.

Optionally, at 218, the data may be saved. The saving of the data may include a voice-to-text conversion such that the compilation may be searched via the audio annotation information, the text information, and/or the captured data. If the captured data includes meta-data about the captured data, this information may be utilized to create searchable information about the multimedia compilation. If the captured data does not include meta-data, the captured data may be OCRed to create data that may be capable of being indexed and/or searched.

At 220, the data may be indexed via the data created by voice-to-text, via the text in the multi-media compilation, the voice-to-text conversion, and/or the OCR data, and/or combinations thereof. This index created may then optionally be searched at 222, such that a large index and/or library of multi-media compilations may be stored and easily searched for replaying at a later date. In this manner, many multi-media compilations may be stored and retrieved and replayed for training purposes, “how-to” programs, as well as many other uses.

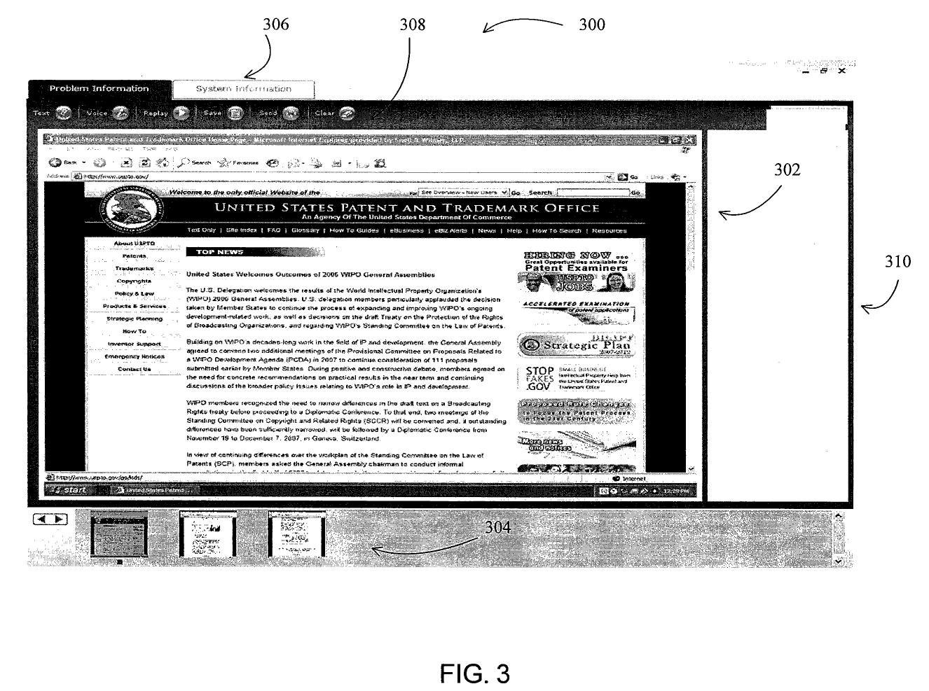

FIG. 3 illustrates an embodiment of captured information and a user interface, at 300. Within the user interface may be included captured data 302 within a captured data portion of the user interface. In this embodiment, the captured data is a screen capture of a website, however, it would be appreciated that many other data captures may be utilized. The user interface may also include a collection of captured data instances at 304 in a collection portion of the user interface. As described above, many instances of data capture may be created and collected such that they may be selected. The created annotated data may then be combined and/or associated with the selected captured data.

The user interface may also include information tabs portion 306. In this embodiment, information tabs include a problem information tab, which may be utilized by software developers to debug software applications. A user may use the captured data, along with the annotated data, to explain problems, bugs, or other impressions of the software and/or captured data. This may be very useful to information for software developers in that a user may do a screen capture and annotate what happened in their own words, along with visual data to indicate where problems may have occurred, nearly as the problem occurs. Again, this use of actual audio data from a user may further communicate more information than is available in a text type or e-mail type application.

Information tab portion 306 may also include a system information tab, which may be populated with information about a user's computer system and software system such that it would further assist a software developer in determining problems that may have occurred with the software program. This tab may also include other information about the hardware/software location, etc. of a user.

User interface may also include a text portion 310, which may allow a user to add text as annotation information. This text information may further enhance the communication between the user and the recipient.

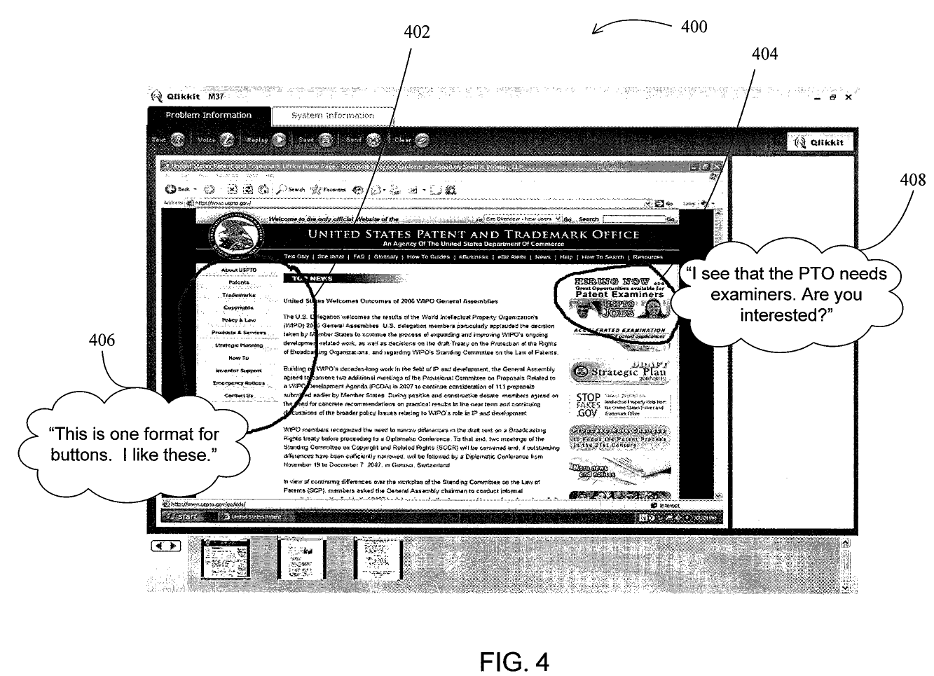

FIG. 4 illustrates captured data and annotated data on a user interface 400, according to one embodiment. In this embodiment, the user interface may indicate visual annotation data 402. In this embodiment, visual annotation data 402 may include visual information such as circling the clickable buttons on the captured data, here a website. This may be accomplished by holding down a mouse button and moving the mouse pointer, and/or any other type of pointer and/or any other type of system and method that may be capable of indicating and/or creating visual data to be added.

Furthermore, a user may create more than one instance of visual annotation data, as evidenced at 404. While creating visual annotation data, a user may speak and create audio annotation data 406, which may be synchronized with visual annotation data 402, such that when the multi-media compilation file is replayed by a recipient, the visual annotation data 402 would appear as the audio annotation data 406 is played. In this instance, a user might circle the buttons on a website and say “This is one format for buttons. I like these.” The audio annotation data 406 again may convey more information to the recipient than mere text data.

Similarly, as visual annotation data 404 is being created, the user could create audio annotation data, such as 408, which may be synchronized with the visual annotation data 404 to further communicate more information. In this instance, the user may circle the “Hiring Now” link on the website and say at the same time “I see that the PTO needs examiners. Are you interested?” This may, again, convey more information in the inflection and the actual audio annotation information 408 that is sent.

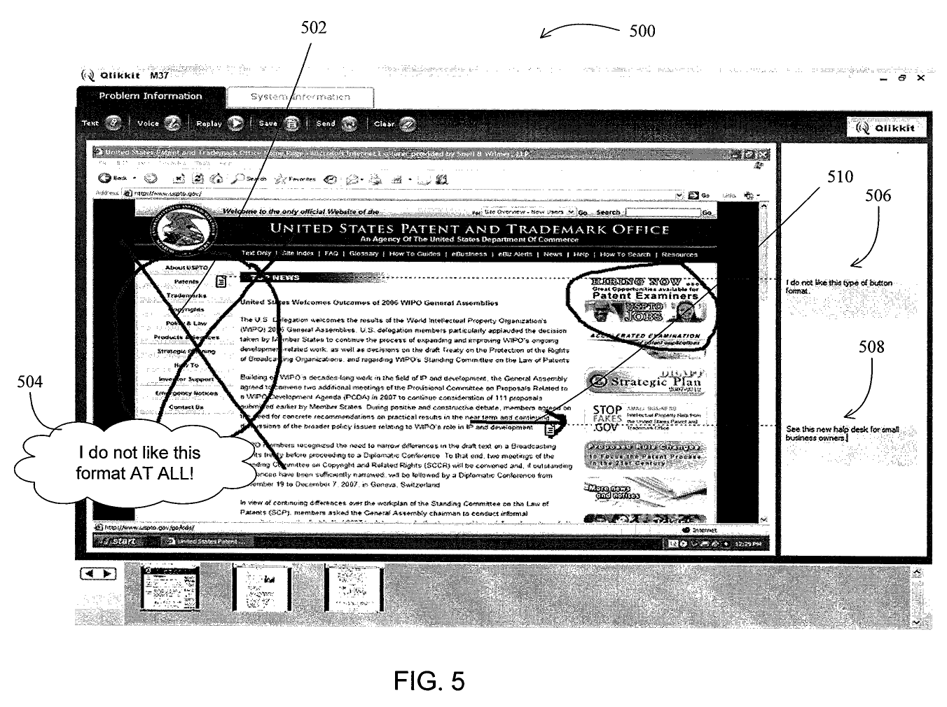

FIG. 5 illustrates another media compilation 500. In this embodiment, a recipient may further add annotation data, such as visual annotation data 502 and audio annotation data 504. In this embodiment, the recipient may “X”-out over the buttons on the website and the visual annotation data provided by the first user and, furthermore, create audio annotation data 504 at the same time. In this embodiment, the user may “X”-over the buttons and say “I do not like this format AT ALL!” which may again convey more information than just a text or other visual information.

Although not shown here, in an embodiment, original annotation data, and/or previous versions of annotation data may appear differently than current annotation data added by the current user. Previous annotation data may generally grayed, dimmed, be of a different gray scale, and/or other method for differentiation.

Furthermore, the recipient may add text data by clicking near the portion that they would like to annotate with text and add text annotation 506 and 508. As can be seen, the user may, in this embodiment, type in “I do not like this type of button format” at 506. In one embodiment, the user may want to create this type of information if their computing platform does not have, or support the creation of audio data.

The user may add more information, such as visual annotation information 510. In this embodiment, an arrow pointing to the StopFakes.gov link for help for small business owners. The user may then click and add text annotation data 508 which, in this embodiment, is “See this new help desk for small business owners.” In this manner, many types of audio and/or visual and/or text and/or combinations thereof may be added to further enhance the communication between a user and a recipient.

It will be appreciated that user and recipient may be used interchangeably as a user may add information and send to recipient, then the recipient may add information and send back to the user many times over. With this system and method, users in remote places may be able to collaborate and send information back and forth that may be added to and/or replayed and/or saved to further enhance the communication and cooperation between users.

This system and method may also be used for “how-to” type media compilation files that may be stored and may be utilized to pass on corporate knowledge and to save corporate knowledge. Furthermore, these media compilation files may be searchable by voice after a voice-to-text conversion, and the text may be then be indexed and searched. Furthermore, an optical character recognition may be done of the captured data to further index and make a searchable collection of media compilation files.

Furthermore, the bookmarks included in the captured data may further allow social book-marking, which may be tied to individual data element on the page, instead of the entire data captured page. This system and method may enable “deep” book-marking by associating textual annotations at a point in the page, instead of at the URL level. This may allow preservation and exploitation of the link from within the captured data.

This system and method may also be very easy to use, such that the application program may be running in the background, and a screen capture or capturing data may be accomplished at any time, which may then open the application program and allow a user to select captured data to be annotated. Furthermore, the user may then easily create the annotated information to be associated and/or combined with the captured data. Then, a user may be simply one click away from sending it to a recipient via communication module, such as an e-mail. In this manner, a user may capture, annotate and send a multi-media compilation file quickly such that more users may use this system and method.

The application may also provide the user with the ability to post the multimedia compilation to be included as part of a blog, video hosting web service, and/or as a podcast, and/or combinations thereof.

This system and method may also provide a reliable cache of information in that the captured data would appear as it appeared when captured, not after the data had been changed, such as website evolution, among many other types of information that may change over time.

This system and method may also create peer-to-peer knowledge management that is relatively easy to create, use, secure and replay. This may also create a media compilation file that may not be modifiable, in that the captured data may be saved as a picture only and may not be modified by a subsequent user, other than adding annotation information. This, again, may be very useful in a “how-to” library where, not only may the captured information include website data or other data, but also any viewable data, such as pictures, documents or other information.

In one embodiment, a user may describe an experience with digital pictures and audio, such that it would be better understood than sending pictures and text alone. For instance, information may be sent that includes how to construct a bench, the audio of the person actually constructing the bench, and pictures of the bench being constructed which may be compiled into a media compilation file that may be used later and repeatedly, such as in a shop class to teach high school students how to use tools and how to assemble a bench.

Furthermore, this software may have many different modules that may allow different aspects to be utilized. It may include capabilities of notifying the distributor that the software had been sent to different people and how many recipients may have received it. This may allow the creator to track user information such that advertising revenues may be better defined and quantified. The system may also include the ability to determine first-time users and different modules being used by users to further determine advertising revenues.

Furthermore, the software may be capable of assigning a serialized number to a user such that the source of the media compilation file may further be authenticated. This system and method may be somewhat spam-proof, in that there is no script language, and the fact that it is a media compilation file of this type, may ensure that the sent file is not a virus or spam. Users may also want to utilize this to send photos and voice data together to further enhance the communication. In one embodiment, a user may want to send pictures of their young child to the grandparents and may include narration in their voice, as well as audio from the child to the grandparents to further enhance the communication experience.

Upon installation of the software, the software may be capable of checking for availability of a newer version (or patches) at a web-site. During this check the software may be capable of sending a unique token identifying the end user machine (this could be CPUID for Intel®-based machines or machine label for Macintosh®-based ones). All unique installs of the software may be tracked in this and/or a similar manner.

When application program is instantiated, and/or at any point when the content of the multimedia compilation is being created, edited, or played, it may be capable of communicating with an advertisement server to determine relevant advertisements, which may be based at least in part upon keywords and/or other indicators. In an embodiment, these indicators may be derived from derived from the content of the multimedia compilation, and/or from additional demographic information that may be provided by the user, among others. The same token used to uniquely identify downloaded instance of the software may be sent along with request parameters. Based at least in part upon the token, it may be possible to track conversion of first time recipients to other than first time users.

When the captured data includes all or part of a web page, the capture module may include the location, size, and URL of the links on the web page. Some of the images and text on the web page may have links to advertisements. When the application program is used to play or replay a multimedia compilation that includes one or more advertisements, these links may be highlighted and made active, such that the user may be able to click on a link and be directed to the associated web page through a web browser or other software. The time, identity of the instance of the application program, and/or other data may then be transmitted to a server such that it may then be used later to determine a cost to the advertiser, or a broker, for the user's click on, or viewing of the embedded advertisement.

When the application program is opened it may be capable of sending a unique identifier along with the token that identifies the end user machine. Based at least in part upon the identifier, the unique tokens may be summed up to determine how many recipients viewed the particular multimedia compilation. This information may be utilized to determine advertising revenue.

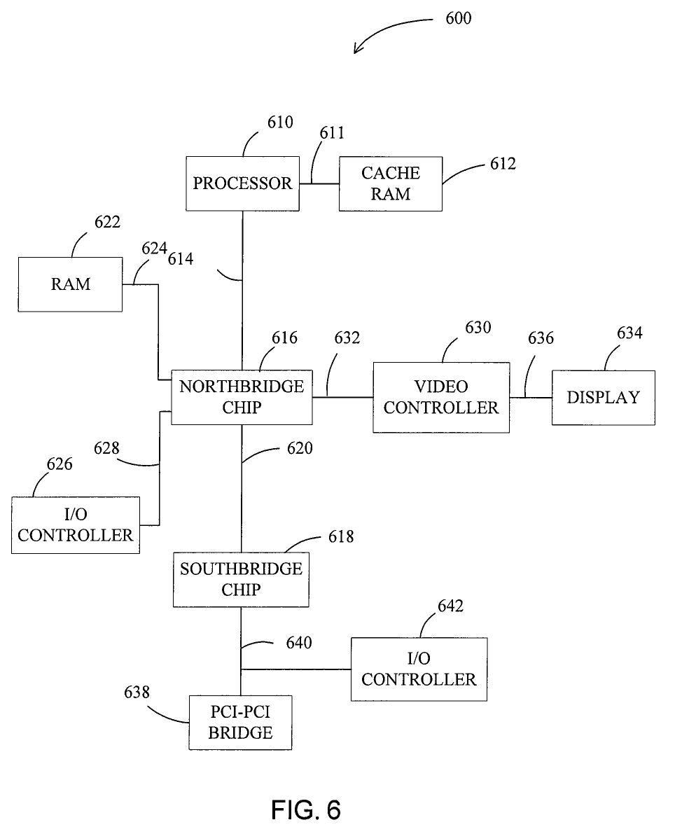

Referring now to FIG. 6, a block diagram of a computing platform capable of executing, creating and transmitting multimedia compilation data in accordance with one or more embodiments will be discussed. It should be noted that computing platform 600 of FIG. 6 is merely one type of computing platform, and other computing platforms having more or fewer components than shown in FIG. 6 may be implemented, and the scope of claimed subject matter is not limited in this respect. In one or more embodiments, computing platform 600 may be utilized to implement method 200 in whole or using more and/or fewer blocks than shown in FIG. 2, and the scope of claimed subject matter is not limited in this respect. Computing platform 600 may include processor 610 coupled to cache random access memory (RAM) 612 via back side bus 611. Processor 610 may also couple to a chipset that includes Northbridge chip 616 via front side bus 614, and also to Southbridge chip 618 via bus 620. In one embodiment, Northbridge chip 616 in general may be utilized to connect a processor to memory, to an input/output bus, to a video bus, and to Level 2 cache, although the scope of claimed subject matter is not limited in this respect.

In one embodiment, Southbridge chip 618 may be utilized to control input/output functions, the basic input/out system (BIOS), and interrupt control functions of Integrated Drive Electronics (IDE) devices such as hard disks or compact disk-read only memory (CD-ROM) devices or the like, although the scope of claimed subject matter is not limited in this respect. Random access memory (RAM) 622 may couple to Northbridge chip 616 via main memory bus 624, and input/output (I/O) controller 626 may also couple to Northbridge chip 616 via I/O bus 628. In one embodiment, I/O controller 626 and I/O bus 628 may be in compliance with a Small Computer Systems Interface (SCSI) specification such as the American National Standards Institute (ANSI) X3.131-1994 SCSI-2 specification, although the scope of claimed subject matter is not limited in this respect. In an alternative embodiment, I/O controller 626 and I/O bus 628 may be in compliance with a Peripheral Component Interconnect (PCI) bus, although the scope of claimed subject matter is not limited in this respect.

Video controller 630 may couple to Northbridge chip 616 via video bus 632, which in one embodiment may comprise an Accelerated Graphics Port (AGP) bus, although the scope of claimed subject matter is not limited in this respect. Video controller 630 may provide video signals to an optionally coupled display 634 via display interface 636 which, in one embodiment, may comprise a Digital Visual Interface (DVI) in compliance with a standard promulgated by the Digital Display Working Group, although the scope of claimed subject matter is not limited in this respect. Southbridge chip 618 may couple to a peripheral component interconnect to peripheral component interconnect (PCI-PCI) bridge 638 via input/output bus 640, which may in turn couple to I/O controller 642 to control various peripheral devices such as Universal Serial Bus (USB) devices, or devices compatible with an Institute of Electrical and Electronics Engineers (IEEE) 1394 specification, although the scope of claimed subject matter is not limited in this respect.

Embodiments claimed may include one or more apparatuses for performing the operations herein. Such an apparatus may be specially constructed for the desired purposes, or it may comprise a general purpose computing device selectively activated and/or reconfigured by a program stored in the device. Such a program may be stored on a storage medium, such as, but not limited to, any type of disk including floppy disks, optical disks, CD-ROMs, magnetic-optical disks, read-only memories (ROMs), random access memories (RAMs), electrically programmable read-only memories (EPROMs), electrically erasable and/or programmable read only memories (EEPROMs), flash memory, magnetic and/or optical cards, and/or any other type of media suitable for storing electronic instructions, and/or capable of being coupled to a system bus for a computing device, computing platform, and/or other information handling system. However, the computer program product may also be capable of being downloaded directly to the computing device, such as, but not limited to, a download over the Internet. This disclosure is intended to cover this carrier wave format.

The processes and/or displays presented herein are not inherently related to any particular computing device and/or other apparatus. Various general purpose systems may be used with programs in accordance with the teachings herein, or a more specialized apparatus may be constructed to perform the desired method. The desired structure for a variety of these systems will appear from the description below. In addition, embodiments are not described with reference to any particular programming language. It will be appreciated that a variety of programming languages may be used to implement the teachings described herein.

In the preceding description and/or following claims, the terms “coupled” and/or “connected,” along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. Furthermore, couple may mean that two objects are in communication with each other, and/or communicate with each other, such as two pieces of software, and/or hardware, or combinations thereof. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

In one or more embodiments, an object may refer to an item that may be selected and/or manipulated, for example shapes, pictures, images, text, and/or text boxes that may appear on a display as rendered by a computing platform coupled to the display. In one or more embodiments, the term render and/or raster may refer to displaying an object on a display coupled to a computing platform, and/or to manipulating the object on the display. In one or more embodiments, graphic may refer to a pictorial and/or image representation of an object, and in one or more alternative embodiments may refer to an object itself. In one or more embodiments, a graphic element may comprise a single and/or fundamental graphic object, and/or a portion thereof. In one or more embodiments, a letterform may comprise a shape and/or design of a letter of an alphabet. In one or more embodiments, a font may refer to a design for a set of characters and/or letters for printing and/or displaying.

In one or more embodiments, text may refer to letters and/or characters that may be manipulated and/or combined as words, lines, and/or pages. However, these are merely example definitions of the above terms, phrases, and/or concepts wherein other definitions may apply as well, and the scope of claimed subject matter is not limited in these respects. In one or more embodiments, file may refer to a collection of data, code, instructions, and/or other information that may be readable, accessible, and/or able to be acted on by a computing platform and/or the like.

In one or more embodiments, a format may refer to a predefined organizational structure for data, code, instructions, and/or other information that may be readable, accessible, and/or able to be acted on by a computing platform and/or the like. In one or more embodiments, a graphical user interface (GUI) may refer to a program interface that utilizes displayed graphical information to allow a user to control and/or operate a computing platform and/or the like.

A pointer may refer to a cursor and/or other symbol that appears on a display screen that may be moved and/or controlled with a pointing device to select objects, and/or input commands via a graphical user interface of a computing platform and/or the like. A pointing device may refer to a device used to control a cursor, to select objects, and/or input commands via a graphical user interface of a computing platform and/or the like. Pointing devices may include, for example, a mouse, a trackball, a track pad, a track stick, a keyboard, a stylus, a digitizing tablet, and/or similar types of devices.

A cursor may refer to a symbol and/or a pointer where an input selection and/or actuation may be made with respect to a region of a graphical user interface. However, these are merely example definitions of terms relating to graphical user interfaces and/or computing platforms and/or the like, and the scope of claimed subject matter is not limited in this respect.

Although the claimed subject matter has been described with a certain degree of particularity, it should be recognized that elements thereof may be altered by persons skilled in the art without departing from the spirit and/or scope of claimed subject matter. It is believed that the subject matter pertaining to creating and transmitting multimedia compilation data and/or many of its attendant utilities will be understood by the forgoing description, Furthermore, it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used in this document, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described in this document is required for the practice of the invention unless expressly described as “essential” or “critical”.

In addition, modifications may be made to the disclosed embodiments without departing from the scope of the disclosure. The scope of this disclosure is therefore not limited to the disclosed embodiments, but is defined by the appended claims. In other words, other variations and modifications of embodiments will be apparent to those of ordinary skill in the art, and it is the intent of the appended claims that such variations and modifications be covered. The particular values and configurations discussed above can be varied, are cited to illustrate particular embodiments, and are not intended to limit the scope of this disclosure. It is contemplated that the implementation of the disclosed embodiments may involve components having different characteristics as long as the elements of at least one of the claims below, or the equivalents thereof, are included.

What is claimed is:

1. A method of creating and transmitting multimedia compilation data, comprising:
capturing data;
creating and synchronizing annotation data;
combining the captured data with the annotation data; and
transmitting the combined data,
wherein the annotated data comprises audio, visual, and/or text data.

2. The method according to claim 1, further comprising collecting an instance of captured data.

3. The method according to claim 2, further comprising selecting an instance of captured data.

4. The method according to claim 1, further comprising compressing the combined data.

5. The method according to claim 1, further comprising playing the combined data at least in part with an application program capable of playing the combined data.

6. The method according to claim 5, further comprising transmitting the application program capable of playing the combined data.

7. The method according to claim 1, further comprising saving the combined data.

8. The method according to claim 7, further comprising indexing the saved data.

9. The method according to claim 8, wherein the indexing comprises a voice-to-text conversion and/or an optical character recognition to create indexed data.

10. The method according to claim 9, further comprising searching the indexed data.

11. The method according to claim 1, wherein the capturing data comprises capturing a screen shot of image data.

12. The method according to claim 1, wherein the annotation data includes audio and visual data.

13. The method according to claim 1, wherein the synchronizing annotation data is accomplished at least in part by utilizing time stamps data.

14. The method according to claim 1, wherein the visual annotation data is overlaid on top of the captured data.

15. The method according to claim 1, wherein the transmitting is accomplished at least in part by utilizing an e-mail-type program.

16. A system capable of creating multimedia compilation data, comprising:
means for capturing data;
means for creating annotation data;
means for combining the captured data and the annotation data, and
means for synchronizing the annotation data,
wherein the annotation data comprises audio and/or somewhat animated visual data.

17. The system according to claim 16, further comprising means for playing the transmitted combined data.

18. The system according to claim 16, further comprising means for saving the combined data.

19. The system according to claim 18, further comprising means for indexing the saved data.

20. The system according to claim 19, further comprising means for searching the indexed data.

21. A computer program product having instructions that, if executed by a computing platform, result in creation and transmission of multimedia compilation data by:
capturing data;
creating and synchronizing annotation data;
combining the captured data with the annotation data;
compressing the combined data; and
transmitting the combined data,
wherein the annotated data comprises audio, visual, and/or text data.

22. The computer program product according to claim 21, further comprising playing the transmitted combined data at least in part with an application program capable of playing the combined data.

23. The computer program product according to claim 22, further comprising transmitting the application program capable of playing the combined data.

24. The computer program product according to claim 21, further comprising saving the combined data.

25. The computer program product according to claim 24, further comprising indexing the saved data.

26. The computer program product according to claim 25, wherein the indexing comprises a voice-to-text conversion and/or an optical character recognition to create indexed data.

27. The computer program product according to claim 26, further comprising searching the indexed data.

28. The computer program product according to claim 21, wherein the visual annotation data is overlaid on top of the captured data.

29. The computer program product according to claim 21, wherein the transmitting is accomplished at least in part by utilizing an e-mail-type program.

30. The computer program product according to claim 21, wherein the computer program product is further capable of identifying an instance of the computer program product.

31. The computer program product according to claim 21, wherein the computer program product is further capable of identifying first-time recipients of the computer program product.

32. The computer program product according to claim 21, wherein the computer program product is further capable of identifying a number of recipients of the computer program product.

33. The computer program product according to claim 21, wherein the computer program product is further capable of preserving and exploiting links from within the captured data.
